(19) United States
(12) Patent Application Publication
(10) Pub. No.: US 2009/0141398 A1
(43) Pub. Date: Jun. 4, 2009

(54) MAGNETIC HEAD AND STORAGE APPARATUS

(75) Inventors: Hideyuki AKIMOTO, Kawasaki (JP); Kenji NOMA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/327,060

(22) Filed: Dec. 3, 2008

(30) Foreign Application Priority Data
Dec. 3, 2007 (JP) 2007-312792
Feb. 21, 2008 (JP) 2008-039896

(51) Int. Cl. G11B 5/17

(52) U.S. Cl. 360/123.01; G9B/5.05

(57) ABSTRACT

A magnetic head has a magnetic main pole and a coil for generating a magnetic flux at the magnetic main pole by energizing the coil. The magnetic main pole is formed as a multi layer structure including at least one magnetic layer and at least one FeRh alloy layer.

### CROSS-REFERENCE TO RELATED APPLICATIONS

This application claims the benefit of priority from Japanese Patent Application No. 2007-312792 filed on Dec. 3, 2007 and Japanese Patent Application No. 2008-39896 filed on Feb. 21, 2008, which is herein incorporated by reference in its entirety.

### BACKGROUND

1. Field

Embodiments of the present invention relate to a structure of a magnetic head.

2. Description of Related Art

Magnetic storage apparatus using a perpendicular magnetic write/read system can improve recording density, in principle. Perpendicular magnetic write heads are basically single magnetic main pole heads but may include trailing shields. On account of the magnetic interaction between the soft magnetic layer and the magnetic main pole, a magnetic field leaking from the air bearing surface of the magnetic main pole does not decrease sufficiently even after the recording operation. This causes the problem of the phenomenon in which magnetic recording information on a medium is disturbed (pole-erase). The key factor in the pole-erase phenomenon lies in residual magnetization of the perpendicular magnetic write head in a direction perpendicular to the air bearing surface (i.e. the lengthwise direction of the head yoke). The amount of residual magnetization of the head depends greatly upon the shape as well as the magnetic characteristics of the write head. As the dimensions (i.e., width, film thickness, and throat height) of the air bearing surface of the magnetic main pole become smaller for high recording density, the residual magnetization of the magnetic main pole becomes larger. This is an increasingly significant problem.

The pole-erase phenomenon can be suppressed by using an excellent soft magnetic material for a magnetic main pole or by forming the magnetic main pole in multi layer (refer to Japanese Laid-open Patent Publication No. 1993-29172).

However, in both the foregoing methods, suppressing the pole-erase phenomenon reduces recording magnetic field intensity as well.

Specifically, using an excellent soft magnetic material for the magnetic main pole generally suffers from the problem that saturated magnetic flux density (Bs) diminishes and hence recording capability becomes degraded. In the case that the magnetic main pole is formed in multi layer, the average Bs of the magnetic main pole diminishes and recording capability diminishes. In the case where Ru (for example) is inserted between the magnetic layers and anti-parallel coupling between the magnetic layers formed upon upper side and lower side of the Ru is utilized, the anti-parallel coupling of the upper and lower magnetic layers sandwiching the Ru is very secure and the pole-erase is effectively suppressed. However, it is difficult to make the magnetization in the magnetic main pole identical during the recording operation. As a result, the recording characteristics become degraded. Alternatively, a method, in which the magnetic exchange coupling force between the upper and lower layers is reduced, may also be applied. This requires thicker nonmagnetic layers made of Ru for example. Alternatively, this requires increased number of separated layers in order to enhance anti-parallel coupling between the magnetic layers formed upper and lower layers. Both of these increase the proportion of nonmagnetic layers to the magnetic layers in the magnetic main pole. This necessarily causes degradation of the recording capability.

### SUMMARY

At least one embodiment of the present invention provides a magnetic head that has a magnetic main pole and a coil for generating a magnetic flux at the magnetic main pole by energizing the coil. The magnetic main pole is formed as a multi layer structure including at least one magnetic layer and at least one FeRh alloy layer.

At least one embodiment of the present invention provides a magnetic head that can reduce, if not suppress, a pole-erase phenomenon without significantly degrading recording characteristics and to provide a storage apparatus including such a magnetic head.

It is to be understood that both the foregoing summary description and the following detailed description are explanatory as to some embodiments of the present invention, and not restrictive of the present invention as claimed.

### BRIEF DESCRIPTION OF THE DRAWINGS

Embodiments are illustrated by way of example and not limited by the following figures.

FIG. 1 is an explanatory view of a write/read head (storage apparatus) according to an example of an embodiment of the present invention.

FIG. 2 is a partial sectional view of a magnetic write/read head according to an example of an embodiment of the present invention.

FIG. 3 is a sectional view showing a configuration of a magnetic pole according to according to an example of an embodiment of the present invention.

FIG. 4 is a graph representing the temperature dependence of the magnetic characteristics of FeRh alloys, e.g., Fe(Rh1-xMx), according to an example of an embodiment of the present invention.

FIG. 5 is an explanatory view showing the magnetizing direction of the magnetic pole according during a recording operation, according to an example of an embodiment of the present invention.

FIG. 6 is an explanatory view showing the magnetizing direction of the magnetic pole according during a non-recording operation, according to an example of an embodiment of the present invention.

FIG. 7 also is sectional view showing the configuration of a magnetic pole according to an example of an embodiment of the present invention.

FIG. 8 also is an explanatory view showing the magnetizing direction of the magnetic pole during a recording operation, according to an example of an embodiment of the present invention.

FIG. 9A and FIG. 9B also are explanatory views showing the magnetizing direction of the magnetic pole during non-recording operation, according to an example of an embodiment of the present invention.

FIG. 10 also is a sectional view of a configuration of a magnetic pole according to an example of an embodiment of the present invention.

FIG. 11 also is an explanatory view showing a magnetizing direction of the magnetic pole during a recording operation, according to an example of an embodiment of the present invention.

FIG. 12 also is an explanatory view showing a magnetizing direction of the magnetic pole during a non-recording operation, according to an example of an embodiment of the present invention.

### DETAILED DESCRIPTION OF EXAMPLES OF EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer between the two elements, or one or more intervening elements may also be present. Like reference numerals refer to like elements throughout.

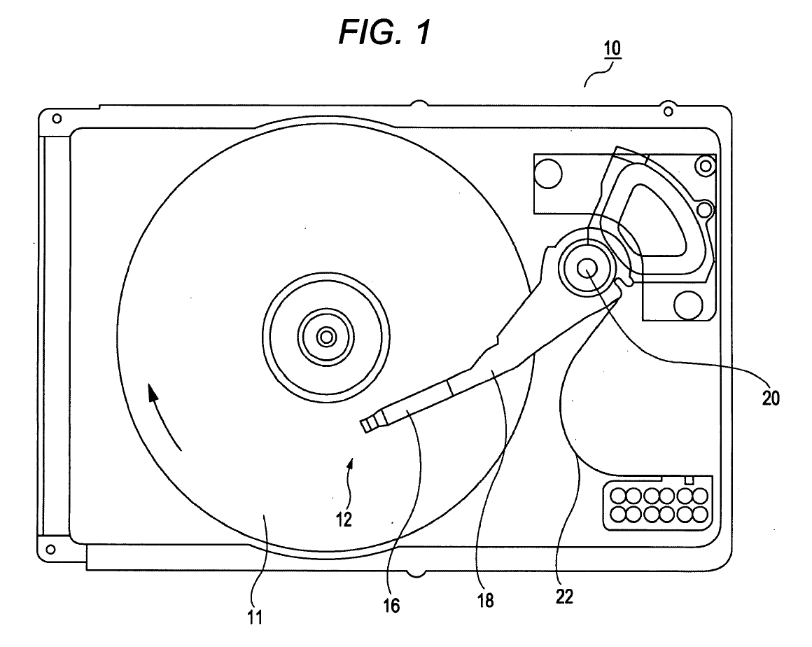

A magnetic write head can be used in a write/read apparatus (storage apparatus) 10, as shown in FIG. 1.

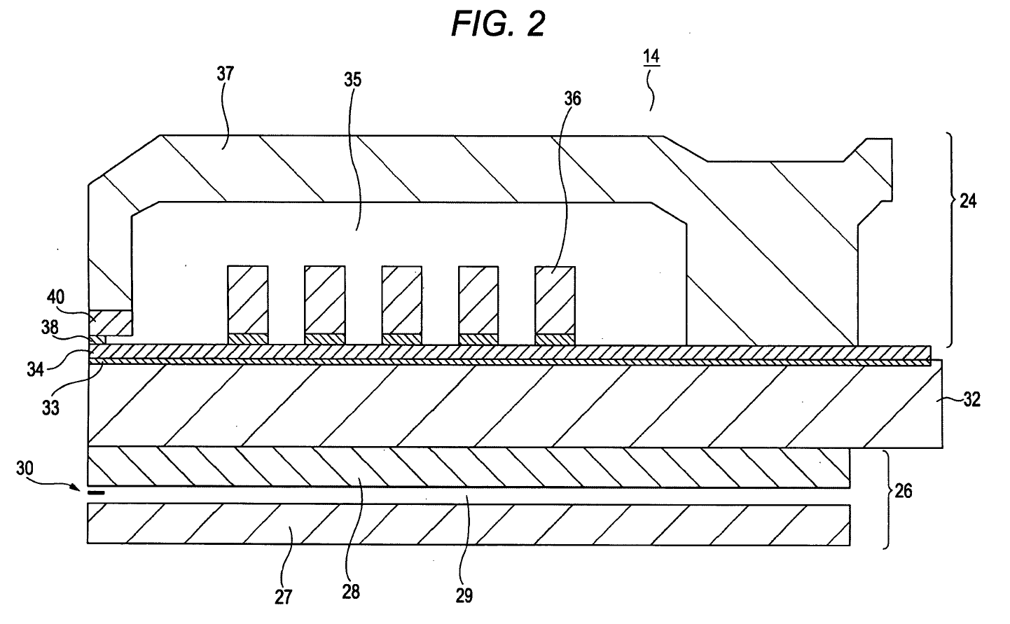

In FIG. 1, a head slider 12 has a magnetic write/read head 14 (e.g., see FIG. 2) for writing information on a medium 11, and reading the written information. The head slider 12 is supported by suspension 16. Suspension 16 is fixed to an actuator arm 18 at one end of the suspension 16.

The actuator arm 18 is rotatable about a shaft 20 by a motor. The magnetic write/read head 14 is electrically connected to a circuit 22. An electric signal for writing information on the medium 11 is transmitted from a control section (not shown) to the magnetic write/read head 14 via an insulated conductive wire (not shown), disposed on the suspension 16 and the actuator arm 18. In response to an instruction from the control section, the read head reads the information written on the medium 11 and transmits the read signal to the control section via the circuit 22.

FIG. 2 is a sectional view of the magnetic write/read head 14 (hereinafter simply referred to as “magnetic head”). The magnetic head 14 has a write head 24 and a read head 26. The read head 26 is configured in such a way that an insulating layer 29 made of alumina is formed between a lower shield layer 27 and an upper shield layer 28 made of FeNi, and a known MR (Magnetic Resistance) sensing section 30 is formed in the insulating layer 29 made of alumina.

An insulating layer 32 is formed on the upper shield layer 28. A power supply layer 33 made of a conductive material is formed on the insulating layer 32. A magnetic main pole 34 having a multi layer structure is formed by a sputtering method on the power supply layer 33. The power supply layer 33 may be formed of a nonmagnetic conductive material, e.g., a noble metal such as Ru, Rh, or Pt, or a nonmagnetic conductive material including any one of these elements, or a magnetic conductive material made of an alloy of two or more elements selected from Fe, Co, and Ni. The magnetic main pole may be made by pattern formation, e.g., by ion milling, RIE (Reactive Ion Etching), wet etching, or the like.

On the magnetic main pole 34, an insulating layer 35 is formed of alumina or the like, and in the insulating layer 35, a coil 36 is formed. A return yoke 37 is formed to cover the insulating layer 35. On the magnetic main pole 34 on its medium (not shown in FIG. 2) side, a nonmagnetic conductive layer 38 is formed. On the return yoke 37 on the medium (not shown in FIG. 2) side, a trailing shield 40 is formed of, e.g., an FeCo plated layer with the nonmagnetic conductive layer 38 as a base for plating.

The trailing shield 40 is optional and is used to increase magnetic field gradation. Accordingly, although FIG. 2 shows a single pole perpendicular magnetic write head with a trailing shield, the single pole perpendicular magnetic head without a trailing shield may be used.

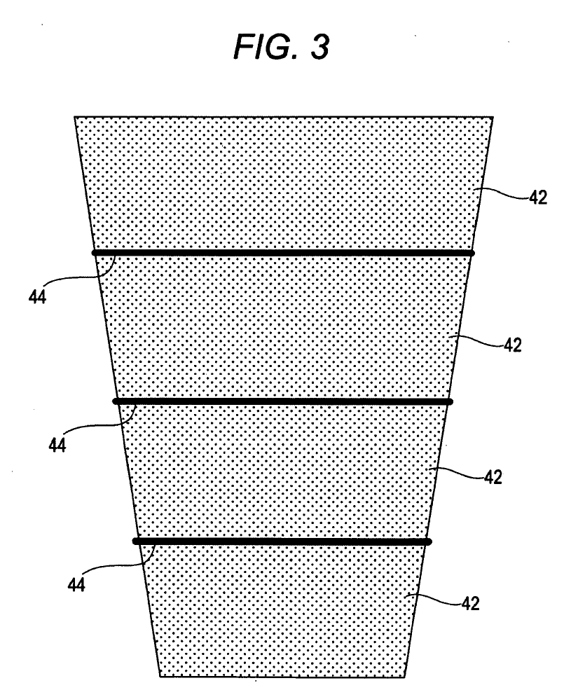

As shown in FIG. 3, a magnetic main pole 34 as a multi-layer structure that includes magnetic layers 42 and iron-rhodium (FeRh) alloy layers 44. The magnetic layers 42 may include FeCo alloy, FeNi alloy, CoNiFe alloy, or the like.

The magnetic layers 42 and the FeRh alloy layers 44 are formed by, e.g., sputtering. In the context of FIG. 3, there is a proportional relation in which the thickness of each of the magnetic layers 42 is, e.g., approximately 50 nm, and each of the FeRh alloy layers 44 is, e.g., approximately several nm. However, the thicknesses of the layers are not limited to these values.

In FIG. 3, for example, four magnetic layers 42 are formed, and three FeRh alloy layers 44 are formed between the magnetic layers 42. However, the number of the magnetic layers 42 and the number of FeRh alloy layers 33 are not limited to this arrangement.

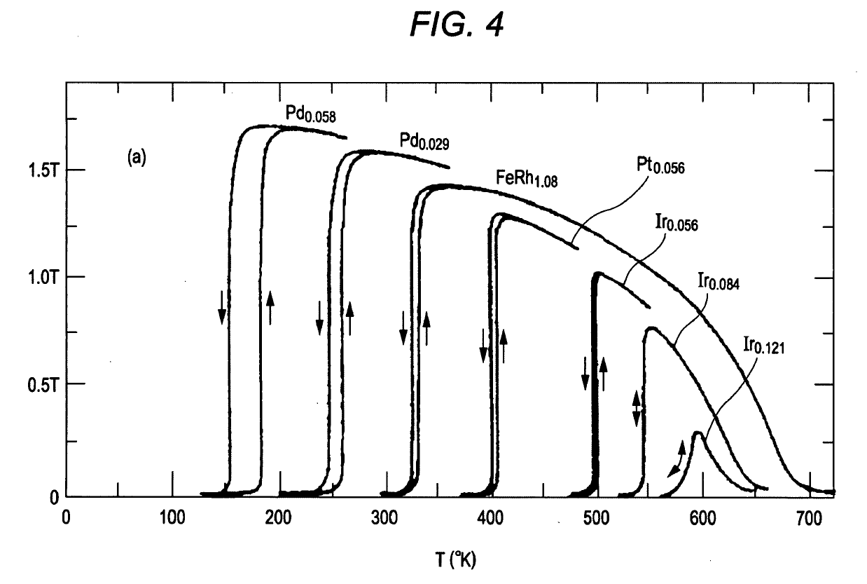

Also in FIG. 3, the magnetic layer 42 of the magnetic main pole 34 is separated into multiple layers to form a multi layer structure. As a material of the separating layer, e.g., FeRh alloy is used. A characteristic of FeRh alloy is that it is demagnetized at a low temperature and becomes ferromagnetic at a high temperature. The transition temperature at which the FeRh alloy becomes ferromagnetic is close to the room temperature. The transition temperature can be controlled by the composition of the FeRh alloy or by adding a third element (e.g., Ir, Pd, or Pt). FIG. 4 is a diagram representing the temperature dependences of magnetic characteristics of various FeRh alloys Fe (Rh1-xMx) (see, e.g., J. S. Kouvel, “Unusual Nature of the Abrupt Magnetic Transition in FeRh and Its Pseudobinary Variant”, Journal of Applied Physics, Vol. 37, No. 3, p.p. 1257-1258 (1966)).

In the write head 24, energizing to a coil makes a recording magnetic field. Energizing to a coil (during recording operation) makes the temperature of the magnetic main pole 34 higher. On the other hand, not energizing to a coil (during non-recording operation) makes the temperature of the magnetic main pole 34 lower to the room temperature. According to the temperature, the magnetic status of the FeRh alloy transits between ferromagnetic and anti-ferromagnetic. Specifically, when the recording operation is not carried out, the FeRh alloy layer 44 becomes demagnetized and functions as an anti-ferromagnetic separate layer and thus the magnetization of the magnetic layers 42 becomes anti-parallel and exhibits the effect of reducing, if not suppressing, a pole-erase magnetic field.

On the other hand, during the recording operation (i.e. during heat generation or heating by energizing to a coil), the FeRh alloy layers 44 behave as a ferromagnetic (Bs=approximately from 1 to 1.5 T, for example, 115 emu/g is approximately equal to 1.5 T), thus ensuring the recording magnetic field intensity.

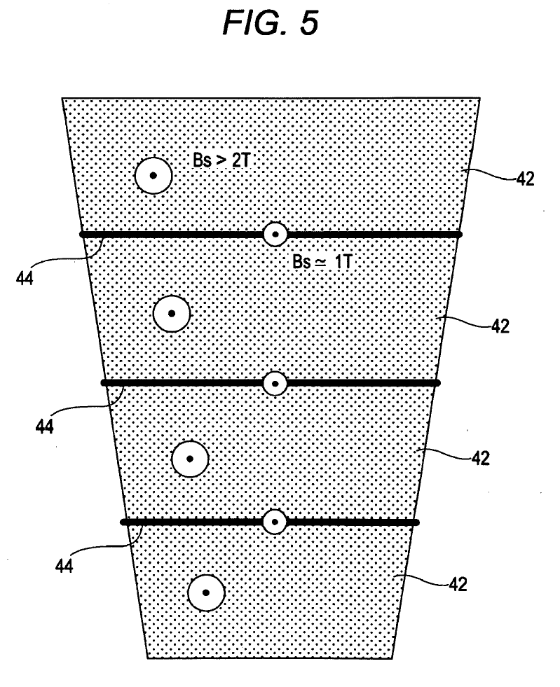

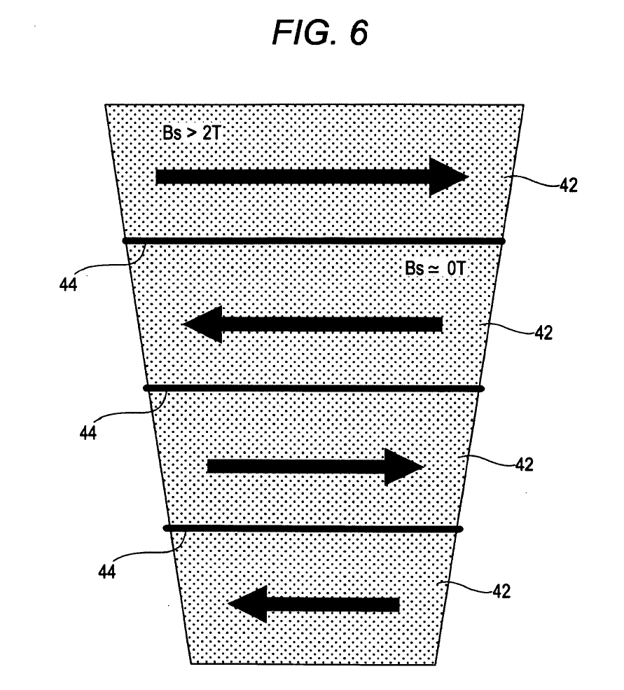

FIG. 5 is a diagram illustrating the state in which the FeRh alloy layer 44 is magnetized during the recording operation, and FIG. 6 is a diagram illustrating the state in which the FeRh alloy layers 44 become anti-ferromagnetic during the non-recording operation, and then the layers are anti-parallely coupled to one another.

To control the height by which the head slider 12 flies from the medium 11, a heater (i.e., resistor) for thermal protrusion of element may be provided in the head slider 12. Specifically, a current different from the recording current is sent to the heater. A part of the heater in the vicinity of the magnetic pole expands toward the medium, thereby controlling the flying height (namely, DFH: Dynamic Flying Height control).

The temperature of the heater may be increased to about 240° C. albeit, e.g., momentarily. As shown in FIG. 4, controlling the type or the amount of the third element added to the FeRh alloy facilitates controlling the transition temperature over a wide range. Accordingly, an FeRh alloy type may be selected so as to have a desired transition temperature depending on the heating of the recording head by the coil 26 or depending on the heating degree of the heater in the DFH. This can facilitate satisfactorily reducing, if not suppressing, the pole-erase phenomenon and obtaining a desired amount of recording magnetic field intensity.

In addition, a further option is to dispose an additional heater near the magnetic main pole, and to energize a coil and control heating only during the recording operation. This can facilitate a sudden significant if not substantial change of the temperature from the recording operation to the non-recording operation and vise versa and, hence, the sudden transition of the magnetic characteristics of the FeRh alloy. In this case, compared to the case where heat is generated by the coil, the temperature change of the FeRh alloy is significant, thus widening the range of suitable compositions of the FeRh alloy.

The FeRh alloy layer 44 with a thickness of approximately 1 to 2 nm yields a pole-erase suppression effect substantially similar if not identical to that in the nonmagnetic multi layer structure using static magnetic coupling. A material which has high Bs and slightly worse soft magnetic characteristics than FeCo alloy or FeNi alloy can be used as a material of the magnetic layers 42 of the magnetic main pole 34 because multi layer structure can reduce, if not suppress, the pole-erase phenomenon. This increases the degree of freedom in material selection.

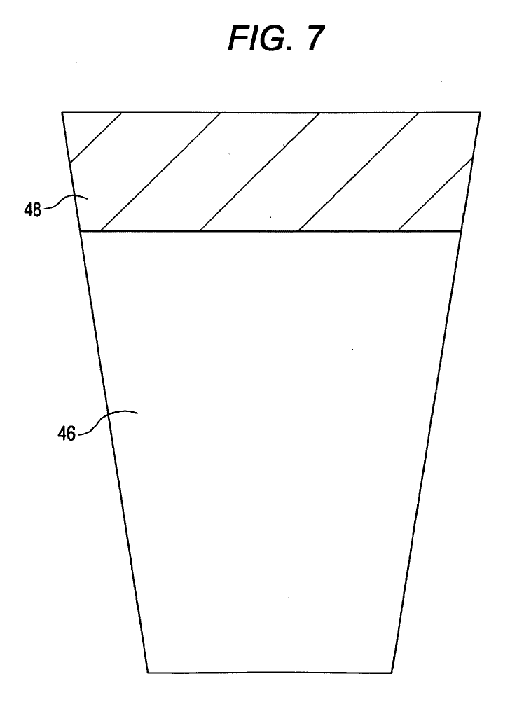

The FeRh alloy becomes anti-ferromagnetic when the temperature is low. To facilitate better magnetically coupling of the magnetic layers 42 anti-parallel to one another, as shown in FIG. 6, it can be helpful to precisely control the thickness of each of the FeRh alloy layers 44. In FIG. 6, an FeRh alloy layer 46 is formed thick to form a magnetic pole with a two-layer structure composed of the FeRh alloy layer 46 that changes magnetic characteristic depending on the temperature and a magnetic layer 48 made of FeCo for example, as shown in FIG. 7. With a method using the two-layer structure composed of the FeRh alloy layer 46 and magnetic layer 48, it is easy to control the thickness of the FeRh alloy layer 46.

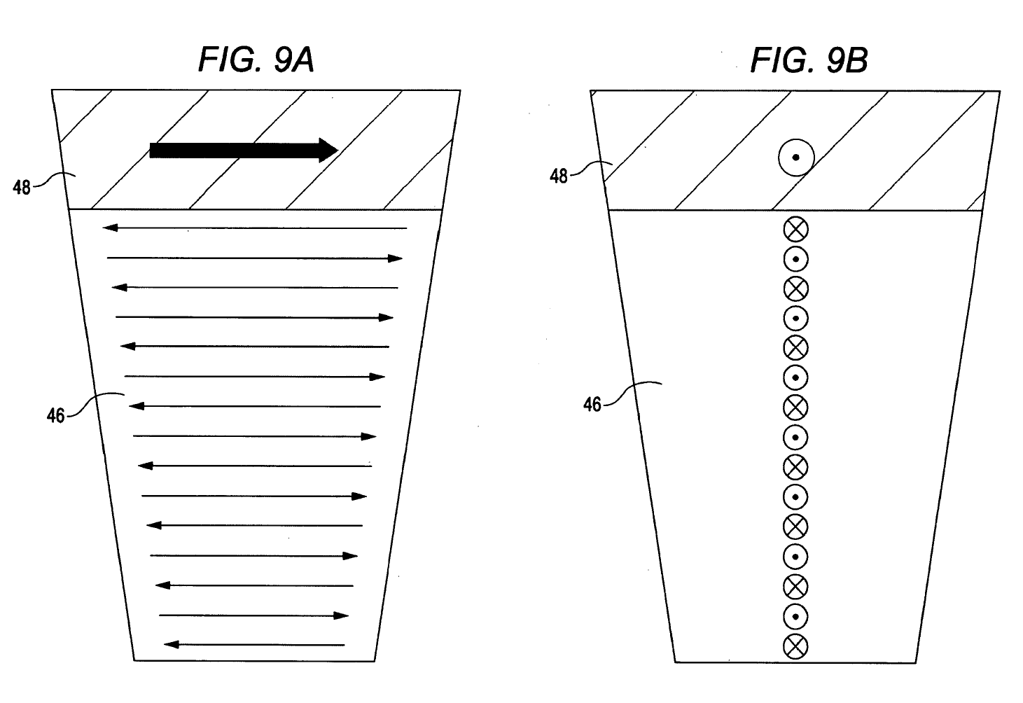

In this structure, the FeRh alloy layer 46 behaves as an anti-ferromagnetic film during a non-recording operation (i.e., when the temperature of the FeRh is low). As shown in FIG. 9A, the magnetization of the FeRh alloy layer 46 is made anti-parallel in the order of atomic, and magnetization observable from outside is apparently zero. This inhibits, if not prevents, the FeRh alloy layer 46 from generating a pole-erase magnetic field. A source generating a pole-erase magnetic field is only a part of the magnetic layer 48 formed on the magnetic pole. Since the magnetic layer 48 represents only the upper part of the magnetic pole, pole-erase due to the magnetic layer 48 is reduced.

The magnetizing direction of the FeRh alloy layer 46 and magnetic layer 48 during the non-recording operation may be perpendicular to the lengthwise direction of the magnetic pole as shown in FIG. 9A (i.e., the magnetizing direction coincides with the direction of the core width) or parallel to the lengthwise direction of the magnetic pole, as shown in FIG. 9B. In the case of the magnetizing direction shown in FIG. 9A, the effect of the pole-erase phenomenon on a medium is less than that in FIG. 9B.

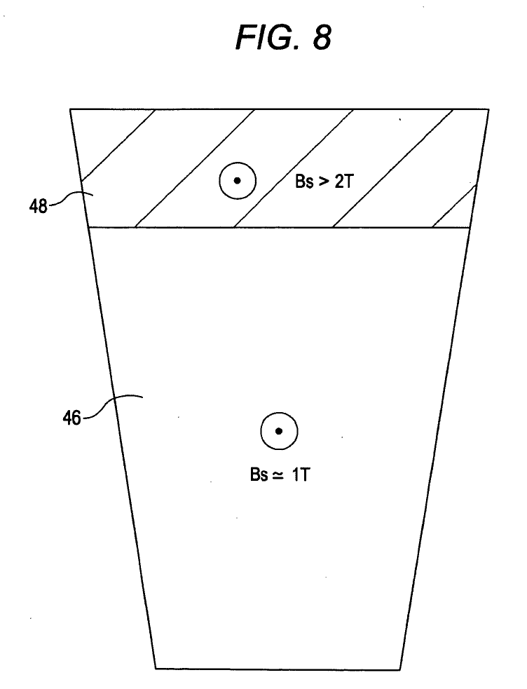

On the other hand, during the recording operation (i.e., when the temperature of the FeRh is high), the FeRh alloy layer 46 behaves as a ferromagnetic film of a magnetization of approximately from 1.0 to 1.5 T, as shown in FIG. 8, and serves as an auxiliary magnetic layer that enhances a recording magnetic field during the recording operation.

The perpendicular magnetic write of the final magnetic recording takes place in the trailing shield side magnetic layer 48. To facilitate the auxiliary magnetic layer aiding the saturation of magnetization of the magnetic layer 48, an option is to use an auxiliary magnetic layer that has a saturated magnetization of approximately 1 T or above. In addition, to facilitate obtaining sufficient recording magnetic field intensity, an option is to set the thickness of the FeRh alloy layer 46 at about four times greater than that of the magnetic layer 48 or smaller.

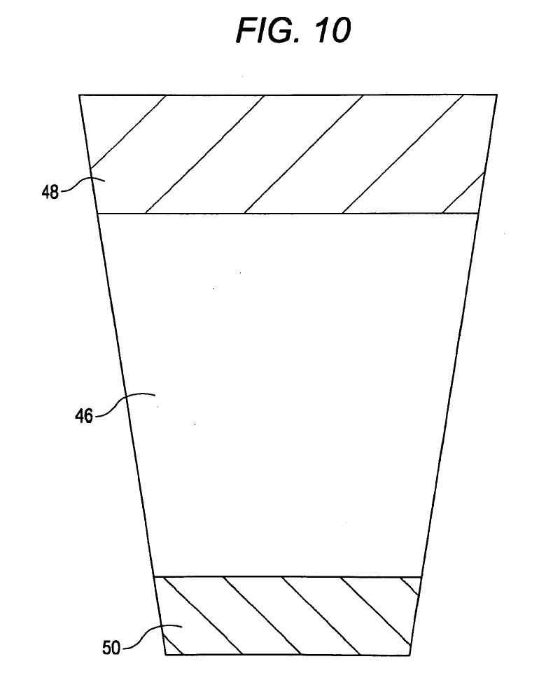

FIG. 10 shows a configuration in which an anti-ferromagnetic layer 50 is provided as an under layer of the FeRh alloy layer 46 in the magnetic structure. The anti-ferromagnetic layer 50 provided as the lowermost layer, is formed such that the magnetization of the uppermost surface is fixed in the widthwise direction of the magnetic pole (i.e., the direction of the core width), and serves to fix the magnetizing direction of the adjacent FeRh alloy layer 46 in the widthwise direction of the magnetic pole.

The exchange coupling force (magnetic field) between the anti-ferromagnetic layer and FeRh alloy layer is Hₑₓ=Jₑₓ/(multiply t_{FeRh} by MS_{FeRh}) (wherein Jₑₓ is the exchange coupling energy of a boundary face, t_{FeRh} is the thickness of the FeRh alloy, and Ms_{FeRh} is the saturated magnetization of the FeRh alloy).

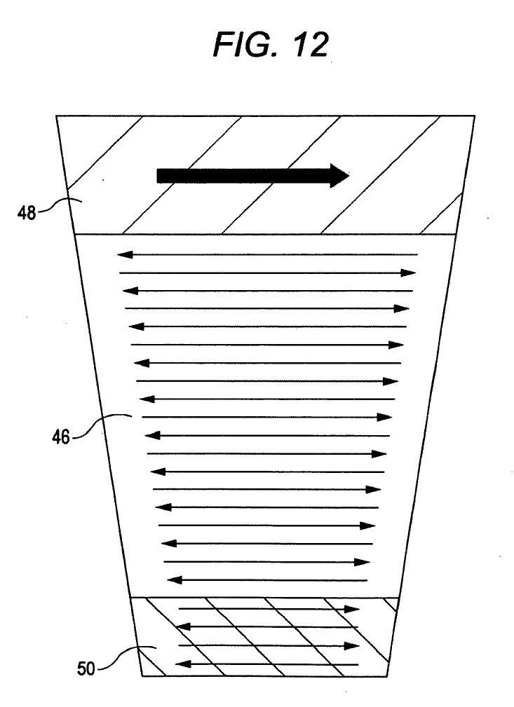

Since the FeRh alloy layer 46 during the non-recording operation is anti-ferromagnetic film, saturated magnetization is almost zero. Consequently, the magnetizing direction of the FeRh alloy layer 46 is fixed in the widthwise direction even with weak exchange coupling force (Jₑₓ). Also, the magnetizing direction of the magnetic layer 48, made of FeCo for example, stacked as an upper layer of the FeRh alloy layer 46, is oriented in the widthwise direction. FIG. 12 shows the state during this non-recording operation.

By thus making the magnetizing direction of the magnetic layer 48 during the non-recording operation coincide with the core widthwise direction, pole-erase by the magnetic pole may be effectively if not suppressed.

Fixedly orienting the magnetizing direction of the anti-ferromagnetic layer 50 in the widthwise direction (i.e., core widthwise direction) may be achieved by annealing the anti-ferromagnetic layer 50, with a magnetic field applied thereto in the widthwise direction. For example, if IrMn is used as the anti-ferromagnetic film, the IrMn is heated to an annealing temperature of approximately 270° C.

In the case where the magnetic pole has the anti-ferromagnetic layer 50, it can be beneficial to use the magnetic pole at temperatures that do not disturb the fixed direction of the magnetization of the anti-ferromagnetic layer 50 during the recording operation.

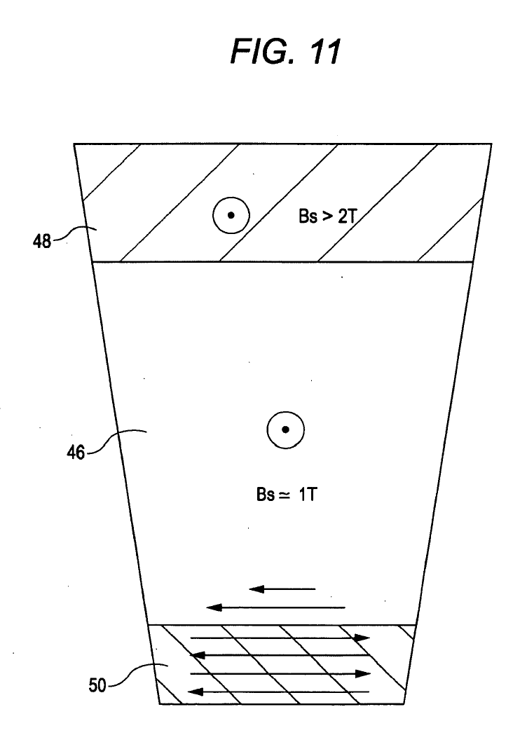

FIG. 11 shows the magnetizing direction of the magnetic pole during the recording operation. Exchange coupling force acts between the anti-ferromagnetic layer 50 and the FeRh alloy layer 46 during the recording operation as well. However, since the saturation of magnetization MsFeRh of the FeRh alloy layer 46 significantly increases, the coupling magnetic field becomes comparatively weak, which slightly decreases recording performance. The effect of the trailing shield side magnetic layer 48 becomes greatest during the magnetic recording, and when the FeRh alloy layer 46 has a magnetization of approximately 1.0 T during the recording operation, sufficient recording magnetic field intensity may be obtained. Because of the reasons described above, an option in all the embodiments is to dispose a magnetic layer of saturated magnetic flux density higher than that of the FeRh alloy serving as a ferromagnetic body during the recording operation on the closest side to the trailing shield.

In the examples described above, descriptions were made for cases where the perpendicular magnetic write head and read head are integrated. However, embodiments of the present invention can also be applied as the magnetic main pole for a single perpendicular magnetic write head. Additionally, embodiments of the present invention allows the foregoing multi layer magnetic pole to be applied not only to the magnetic pole for the perpendicular magnetic write head but also to that for a longitudinal magnetic write head.

According to the magnetic head and storage apparatus disclosed above, the FeRh alloy layer of the magnetic pole becomes demagnetized and acts as an anti-ferromagnetic layer during the no-recording operation (i.e., when the temperature is low), thereby appropriate reducing, if not suppressing, a pole-erase phenomenon. On the other hand, during the recording operation (when the temperature is high), the FeRh alloy layer of the magnetic main pole becomes ferromagnetic, thereby facilitating a sufficiently intense recording magnetic field and maintaining satisfactory recording characteristics.

Examples of embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as set forth in the claims.

1. A magnetic head with a magnetic main pole and a coil for generating a magnetic flux at the magnetic main pole by energizing the coil,
wherein the magnetic main pole is formed as a multi layer structure including at least one magnetic layer and at least one FeRh alloy layer.

2. The magnetic head according to claim 1,
wherein the multi layer structure includes a plurality of magnetic layers,
the FeRh alloy of the FeRh alloy layer is ferromagnetic when the coil is energized and is anti-ferromagnetic when the coil is not energized, and
when the coil is not energized, the magnetization of the magnetic layers are anti-parallely coupled to one another.

3. The magnetic head according to claim 1,
wherein the FeRh alloy of the FeRh alloy layer includes Ir, Pd, or Pt.

4. The magnetic head according to claim 2,
wherein the FeRh alloy of the FeRh alloy layer includes Ir, Pd, or Pt.

5. The magnetic head according to claim 1,
wherein the multi layer structure has a magnetic layer and a FeRh alloy layer, and
the FeRh alloy of the FeRh alloy layer is ferromagnetic when the coil is energized and is anti-ferromagnetic when the coil is not energized.

6. The magnetic head according to claim 5,
wherein the FeRh alloy layer has an anti-ferromagnetic layer opposite to the magnetic layer, and
the anti-ferromagnetic layer being anisotropic in one direction.

7. The magnetic head according to claim 1,
wherein the saturated magnetic flux density of the FeRh alloy layer when the coil is energized is lower than the saturated magnetic flux density of the magnetic layer.

8. The magnetic head according to claim 1, further comprising;
a heater disposed near the magnetic main pole,
wherein the FeRh alloy of the FeRh alloy layer becomes a ferromagnetic layer by energizing the heater.

9. A storage apparatus comprising:
a head slider including a magnetic head to write information on a magnetic recording medium;
a suspension to support the head slider;
a freely rotatable actuator arm to support one end of the suspension; and
a circuit to provide used for writing information on a medium,
the magnetic write head including a magnetic main pole, and a coil to generate a magnetic flux at the magnetic main pole by being energized based upon the electric signal from the circuit, and
the magnetic main pole being formed as a multi layer structure including at least one magnetic layer and at least one FeRh alloy layer.

10. The storage apparatus according to claim 9,
wherein the multi layer structure includes a plurality of magnetic layers,
the FeRh alloy of the FeRh alloy layer is ferromagnetic when the coil is energized and is anti-ferromagnetic when the coil is not energized; and when the coil is not energized, and
the magnetization of the magnetic layers are anti-parallely coupled to one another.

11. The storage apparatus according to claim 9,
wherein the FeRh alloy of the FeRh alloy layer includes Ir, Pd, or Pt.

12. The storage apparatus according to claim 10,
wherein the FeRh alloy of the FeRh alloy layer includes Ir, Pd, or Pt.

13. The storage apparatus according to claim 9,
wherein the multi layer structure has a magnetic layer and an FeRh alloy layer, and
the FeRh alloy of the FeRh alloy layer is ferromagnetic when the coil is energized and is anti-ferromagnetic when the coil is not energized.

14. The storage apparatus according to claim 13,
wherein the FeRh alloy layer has an anti-ferromagnetic layer opposite to the magnetic layer, the anti-ferromagnetic layer being anisotropic in one direction.

15. The storage apparatus according to claim 9,
wherein the saturated magnetic flux density of the FeRh alloy layer when the coil is energized is lower than the saturated magnetic flux density of the magnetic layer.

16. The storage apparatus according to claim 15,
wherein the most trailing shield side of the magnetic main pole is the magnetic layer.

17. The storage apparatus according to claim 9, further comprising;
a heater disposed near the magnetic main pole,
wherein the FeRh alloy of the FeRh alloy layer becomes a ferromagnetic layer by energizing the heater.
